(19) United States
(12) Patent Application Publication
(10) Pub. No.: US 2008/0114865 A1
(43) Pub. Date: May 15, 2008

(54) METHODS AND APPARATUS TO MANAGE COMPUTING PLATFORMS

(76) Inventors: Michael A. Rothman, Puyallup, WA (US); Vincent J. Zimmer, Federal Way, WA (US)

Correspondence Address: Hanely Flight & Zimmerman, LLC, 150 S. Wacker Drive, Suite 2100, Chicago, IL, 60606, US

(21) Appl. No.: 11/559,673

(22) Filed: Nov. 14, 2006

(51) Int. Cl. G06F 15/173

(52) U.S. Cl. 709/223

(57) ABSTRACT

Methods and apparatus to manage computing platforms are disclosed. An example method comprises receiving a first electromagnetic signal at a computing platform, determining a location of the computing platform based on the received electromagnetic signal within at least one of a manageability engine, active management technology or an embedded information technology (IT) partition, and sending a location packet that contains the location and an identifier for the computing platform.

### FIELD OF THE DISCLOSURE

This disclosure relates generally computing platforms and, more particularly, to methods and apparatus to manage computing platforms.

### BACKGROUND

Network servers are becoming increasingly important for the management of networks, host data, and otherwise to execute a wide variety of networking and/or computing tasks. As such, an enterprise may have hundreds, if not thousands, of computing platforms, such as blade servers mounted in racks. In fact, an enterprise may have rooms dedicated to housing racks of blade servers in buildings strewn throughout a country or even the world. Alternatively or additionally, an enterprise may have hundreds, if not thousands, of standalone computers located at any number of locations.

### BRIEF DESCRIPTION OF THE DRAWINGS

FIG. 1 is a schematic illustration of an example system to manage computing platforms constructed in accordance with the teachings of the invention.

FIG. 2 illustrates an example manner of implementing any or all of the example computing platforms of FIG. 1.

FIGS. 3A and 3B illustrate example manners of implementing any or all of the example coded instructions of FIG. 2.

FIGS. 4A and 4B illustrate example data structures that may be used to implement a location packet.

FIGS. 5 and 6 are flowcharts representative of example machine accessible instructions which may be executed to implement the example location agents of FIGS. 3A and 3B.

FIG. 7 illustrates an example data structure that may be used to implement a database of computing platform locations.

### DETAILED DESCRIPTION

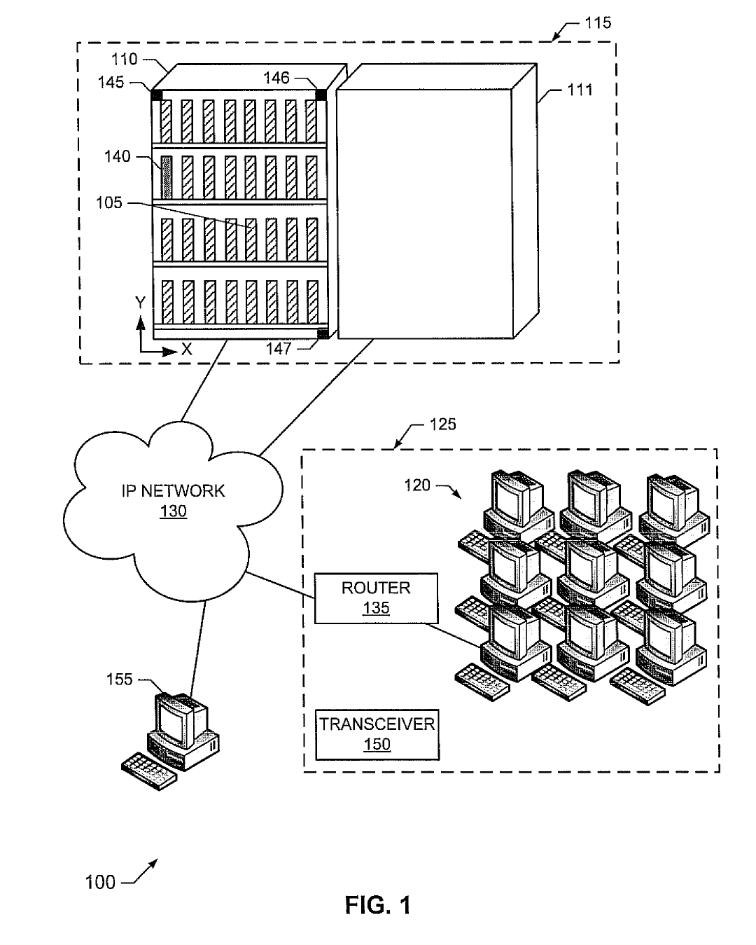

FIG. 1 is a schematic illustration of an example system 100 to manage computing platforms. In the interest of brevity and clarity, throughout the following descriptions references will be made to the example system 100 of FIG. 1. However, persons of ordinary skill in the art will readily appreciate that the methods and apparatus described herein to manage computing platforms can be applied to any topology(-ies), number and/or type(s) of computing systems and/or computing platforms.

The example system 100 of FIG. 1 includes any number and/or type(s) of computing platforms, such as any number and/or types(s) of blade servers, a particular one of which is referred to in FIG. 1 with reference numeral 105, contained in and/or implemented by any number of racks, two of which are identified in FIG. 1 with reference numerals 110 and 111. The example racks 110, 111 of FIG. 1 are located at and/or implemented within an example site and/or location 115. However, the example racks 110, 111 may be implemented and/or located at any number of sites and/or locations. Moreover, the racks 110, 111 need not be located at the same site and/or location.

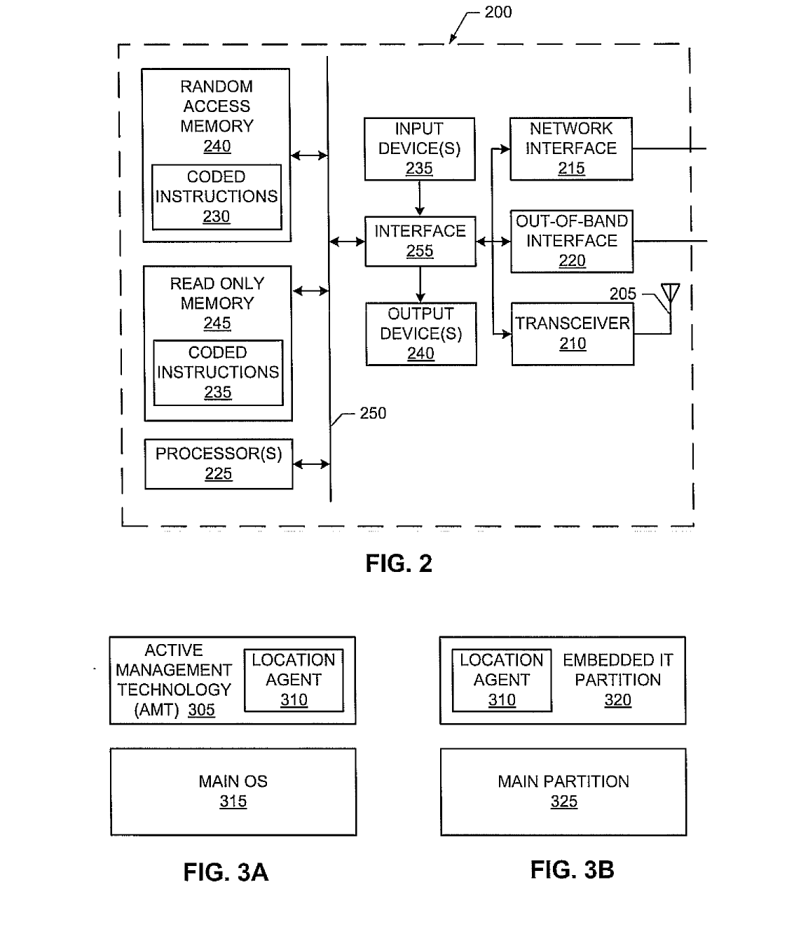

The example system 100 of FIG. 1 further includes any number and/or type(s) of standalone computing platforms 120, such as workstations, personal computers, laptops, personal digital assistants, smart phones, etc. The example standalone computing platforms 120 of FIG. 1 are located at and/or implemented within a second site and/or location 125. However, additionally or alternatively, the standalone computing platforms 120 may be implemented and/or located at any number of sites and/or locations, possibly including the example site 115. An example manner of implementing any or all of the example computing platforms 105, 120 of FIG. 1 is described below in connection with FIGS. 2, 3A-B, 5 and 6.

To communicatively couple some or all of the example computing platforms 105, 120 of FIG. 1, the example system 100 of FIG. 1 includes any number and/or type(s) of public and/or private Internet protocol (IP) based networks 130, such as the Internet, a public local area network (LAN), a private LAN, a wide area network (WAN), etc. The example computing platforms 105, 120 of FIG. 1 are communicatively coupled to the example IP network 130 via any past, present and/or future communication technology, communication protocol(s), communication device(s) and/or as defined by any past, present and/or future standard(s) and/or specification(s), such as the Institute of Electrical and Electronic Engineers (IEEE) 802.3x family of standards for Ethernet and/or the IEEE 802.11x family of standards for wireless communications. In some examples, some or all of the example computing platforms 105, 120 may be communicatively coupled via any number and/or type(s) of intermediary devices, such as router(s) 135, switch(es), gateway(s) and/or bridge(s).

The example blade server 105 and any or all of the other blade servers of FIG. 1 are mounted via edge connectors into slots organized in an array fashion within the example racks 110, 111. When the edge connector of a blade server is inserted into one of the slots of the racks 110, 111, power is delivered to the blade server. In the example of FIG. 1, the blade servers are illustrated as being vertically mounted in rows. However, the blade servers may be mounted using any of a variety of alternative and/or additional arrangements, such as horizontally in columns.

The example blade server 105 and any or all of the other blade servers of FIG. 1 are further communicatively coupled via an out-of-band channel to a management module 140. The example management module 140 of FIG. 1 is an independent hardware module with dedicated firmware to perform management functions, such as for example, coordinating arbitration and allocation of shared resources between blade servers, logging system errors, coordinating fault resilient booting of the blade servers, fan control, and/or power supply monitoring and/or regulation. The example management module 140 is able to grant and/or deny each of the blade servers access to the example IP network 130. The example management module 140 has a known IP address which can be accessed by a remote user (e.g., a network operator) via the IP network 130.

In some examples, the management module 140 is a Unified Management Module (UMM). In the illustrated example, a UMM 140 is substantially similar to the example blade server 105, however, the UMM 140 includes specialized firmware and/or software for conducting management functions. That is, the management module 140 also a computing platform. In other examples, the management module 140 may be a chassis management module mounted to a rack 110, 111 (not illustrated), that performs similar functions to a UMM.

To provide signals that may be used to determine the location of a computing platform 105, 120, the example system 100 of FIG. 1 includes any number and/or type(s) of transceivers, four of which are illustrated in FIG. 1 with reference numerals 145, 146, 147 and 150. The example transceivers 145-147 of FIG. 1 are transceivers connected to and/or built into the example rack 110. The transceivers 145-147 transmit electromagnetic signals, such as radio frequency (RF) signals and/or RF identification (RFID) signals, that may be used by any of the blade servers 105 implemented by and/or within the rack 110 to determine their location within the rack. Persons of ordinary skill in the art will readily recognize that the example rack 111 likewise contains similar transceivers that enable blade servers implemented by the rack 111 to determine their location within the rack 111.

The example blade server 105 of FIG. 1 (and any or all of the other blade servers) determines it location by transmitting an electromagnetic signal, such as a RF and/or RFID query signal, that directs each of the example transceivers 145-147 to transmit an electromagnetic signal, such as a RF and/or RFID response signal. The example transceivers 145-147 of FIG. 1 may transmit signals at substantially the same time and/or at different times. Further, the transceivers 145-147 may transmit an electromagnetic signal having the same and/or different frequencies, and/or having the same and/or different content. The example blade servers 140 of FIG. 1 are able to identify the rack 110, 110 in which they are implemented by, for example, querying a management module 140, a UMM 140 and/or CMM associated and/or implemented by the rack 110, 111.

The example blade server 105 of FIG. 1 measures the strength of the received electromagnetic signals, and uses two or more of the measured signal strengths to determine its location within the rack 110, 111. In particular, for each of the transceivers 145-147, the example blade servers 105 of FIG. 1 compute a distance to each of the transceivers 145-147 using, for example, the following mathematical expression:

$$PowerLevel = \frac{{Power}_{TX} \cdot {Gain}_{TX} \cdot {Gain}_{RX} \cdot {λ}^{2}}{{( 4 π Z )}^{2}} , \qquad EQN ( 1 )$$

where Power_{TX} is the power of the transmitted signal, Gain_{TX} is the gain of the transmit antenna (not shown) used by the transceiver 145-147 to transmit the signal, Gain_{RX} is the gain of an antenna used to receive the signal (e.g., the example antenna 205 of FIG. 2), λ is the wavelength of the transmitted electromagnetic signal, and Z corresponds to the distance to the transmitting transceiver 145-147. Using, for example, the mathematical expression of EQN (1), the blade server 105 computes a length Z₁ to the transceiver 145, a length Z₂ to the transceiver 146 and a length Z₃ to the transceiver 147 based on respective received signal powers. Using any number and/or type(s) of algorithms, equation(s), method(s) and/or logic, the example blade server 105 of FIG. 1 determines its location within the rack (e.g., X and Y coordinates) based upon two or more of the lengths Z₁, Z₂ and Z₃. For example, the blade server 105 can use any type of triangulation algorithm and/or equation(s) to determine its location and to correlate the same to a particular shelf and slot of a rack 110, 111. An example triangulation method is described in U.S. Patent Publication No. 2005/0138439, entitled “Remote Query of a Blade Server's Physical Location,” and published on Jun. 23, 2005. U.S. Patent Publication No. 2005/0138439 is hereby incorporated by reference in its entirety.

Additionally or alternatively, the blade server 105 and any or all of the other blade servers of FIG. 1 may determine their location via any of a variety of additional and/or alternative method(s), technique(s), algorithm(s), signal(s) and/or logic. For example, the blade servers may use a one-way delay and/or a bi-directional propagation delay associated with a received signal to determine the distance Zᵢ to a particular transceiver 145-147. In another example, one or more of the transceivers 145-147 (possibly under the direction of the management module 140) send an electromagnetic signal that directs a particular blade server to respond by sending an electromagnetic signal that the transceivers 145-147 and/or the management module 140 can use to determine the distances Zᵢ and, thus, the location of the blade server within the rack 110, 111. In still further examples, the blade servers can utilize one or more values acquired from a backplane of the rack 110, 111 and/or a shelf of a rack 110, 111 to determine its location within the rack 110, 111.

The example standalone computing platforms 120 of FIG. 1 compute and/or determine their location by measuring and/or receiving one or more electromagnetic signals transmitted by one or more transceivers 150. Based upon the measured and/or received electromagnetic signal(s), the example computing platforms 120 determine and/or identify the closest transceiver 150. The location of the transceiver 150 is then used to identify the location of the computing platform 120. For example, if a particular computing platform 120 receives and/or detects a signal transmitted by a WLAN access point 150 located in lab 315 of building 2 is detected, the computing platform 120 can identify that it is located in lab 315 of building 2. In other examples, a computing platform 120 can identify the MAC address and/or IP address of a router 135, switch, hub, gateway and/or bridge to which it is communicatively coupled to identify its location. For example, a computing platform 120 can obtain and report the IP address of the router 135 to identify its location. The IP address of the router 135 can then be correlated to the location of the identified router 135 to determine the physical location of the computing platform 120. In still others examples, the transceiver 150 may be any variety of RF transceiver 150, such as a RF identification (RFID) tag and/or device that when queried by a nearby computing device 120 returns its unique identifier. Such an identifier, can, like the IP address of the example router 135, be correlated to the location of the transceiver 150 and, thus, the physical location of the computing platform 120.

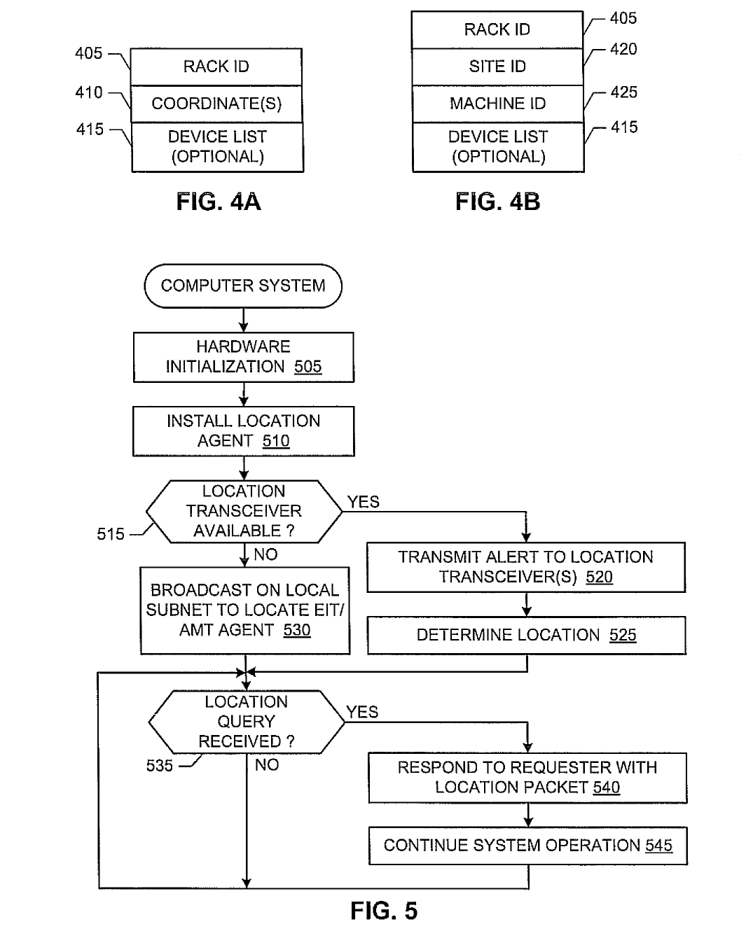

When queried, the example computing platforms 105, 120 of FIG. 1 report their location by sending a location packet to a requesting device. The example computing platforms 105, 120 may determine their location when queried and/or may simply report a previously determined location (e.g., determined during boot and/or initialization). Alternatively, when a computing platform 105, 120 boots and/or is initialized, it determines and reports its location to a management device, such as a UMM, a CMM, and/or another computing platform 105, 120 that is serving as an agent on behalf of the computing platform 105, 120. Example data structures that may be used to implement a location packet are described below in connection with FIGS. 4A and 4B.

To allow a user, such as a technician and/or network operator, to locate and/or manage the example computing platform 105, 120, the example system 100 of FIG. 1 includes a computer 155. While in the example system 100 of FIG. 1, the computer 155 is illustrated as being implemented separately from the example computing platforms 105, 120 and 140, the computer 155 may be implemented by any of the example computing platforms 105, 120 and/or 140. Moreover, while a single computer 155 for use by a technician and/or network operator is shown in FIG. 1, any number of such computers 155 may be implemented by a computer system. For example, two or more computers 155 may be implemented to construct a global database of computing platform locations. For instance, some of the example computing platforms 105, 120 may be designated as agents to collect location information for a subset of the computing platforms 105, 120. Such location information may then be exchanged amongst the computer(s) 155 and/or the agents to provide accessibility and/or fail-over recovery.

The example computer 155 of FIG. 1 is able to query one or more of the computing platforms 105, 120 to obtain its location. In some examples, the computer 155 interacts with a manageability engine, active management technology (AMT), and/or embedded information technology (IT) partition implemented and/or provided by the computing platform 105, 120. Such active management technology, manageability engines and/or embedded IT partitions may be able to determine and/or provide location information even when a main partition and/or general purpose OS is non-functional, and/or even if a computing platform 105, 120 is not currently turned on. In other examples, the computer 155 interacts with the computing platforms 105, 120 via an intermediary, such as the example management module 140. In still further examples, the computer 155 implements and/or stores a database that contains a list of computing platform identifiers and respective location information. Such a database may be, for example, queried to determine the location of a computing platform 105, 120. An example data structure that may be used to store computing platform location information is described below in connection with FIG. 7.

FIG. 2 illustrates an example manner of implementing any or all of the example computing platforms 105, 120 of FIG. 1. However, while FIG. 2 can represent one or more of the example computing devices 105, 120, for ease of discussion, in the following description the example device of FIG. 2 will be referred to as computing device 200. To transmit and receive electromagnetic signals, such as RF signals, RFID signals, WLAN signals, etc., the example computing platform 200 of FIG. 2 includes any number and/or type(s) of antennas 205 and any number and/or type(s) of transceivers 210. The example antenna 205 and the example transceiver 210 of FIG. 2 are able to receive, demodulate and decode RF, RFID and/or WLAN signals transmitted by transceivers (e.g., the example transceivers 145-147, 150 of FIG. 1). Likewise, the wireless modem 210 and the RF antenna 205 are able to encode, modulate and transmit RF, RFID and/or WLAN signals to other transceivers.

To communicatively couple the example computing platform 200 of FIG. 2 to another device and/or network (e.g., a local area network (LAN), a modem, the example router 135, a bridge, a gateway and/or the example IP network 130 of FIG. 1), the example computing platform 200 of FIG. 2 includes any number and/or type(s) of network interfaces 215. The example network interface 215 of FIG. 2 operates in accordance with any of the IEEE 802.3x (a.k.a. Ethernet) family of standards and/or the IEEE 802.11x (a.k.a. WiFi) family of standards.

To communicatively couple the example computing platform 200 of FIG. 1 to any type of out-of-band communication channel, the example computing platform 200 includes an out-of-band communication interface 220. The example out-of-band communication interface 220 of FIG. 2 implements any type of out-of-band communications protocol(s) and/or technology(-ies), such as those implemented as part of a computing platform that implements active management technologies, a manageability engine and/or an embedded IT partition. In some examples, the out-of-band communication interface 220 is implemented by and/or via the example network interface 215.

To determine its location and/or respond to a location request, the example computing platform 200 of FIG. 2 includes any number and/or type(s) of processors 225 that implement, among other things, a location agent (e.g., the example location agent 310 of FIGS. 3A and 3B). The example processor(s) 225 of FIG. 2 may be one or more of any type(s) of processors such as, for example, processors and/or cores contained in, for example, a single-processor, a multiple-processor and/or multi-core computing device. The example processor(s) 225 of FIG. 2 execute coded instructions 230 and/or 235 which may be present in a main memory of the processor 225 (e.g., within a random-access memory (RAM) 240 and/or a read-only memory (ROM) 245) and/or within an on-board memory of the processor(s) 225. The example processor(s) 225 may execute, among other things, the example machine accessible instructions illustrated in FIGS. 5 and/or 7 to implement the location agent 310.

FIG. 3A illustrates an example manner of implementing the example coded instructions 230, 235 of FIG. 2. To implement active management technology(-ies), the example coded instructions of FIG. 3A include active management technology (AMT) coded instructions 305 that may be executed by, for example, a manageability engine. Such a manageability engine may be implemented by and/or within the example processor(s) 225 of FIG. 2. For example, the manageability engine may be a separate processor and/or core implemented by and/or within the processors(s) 225.

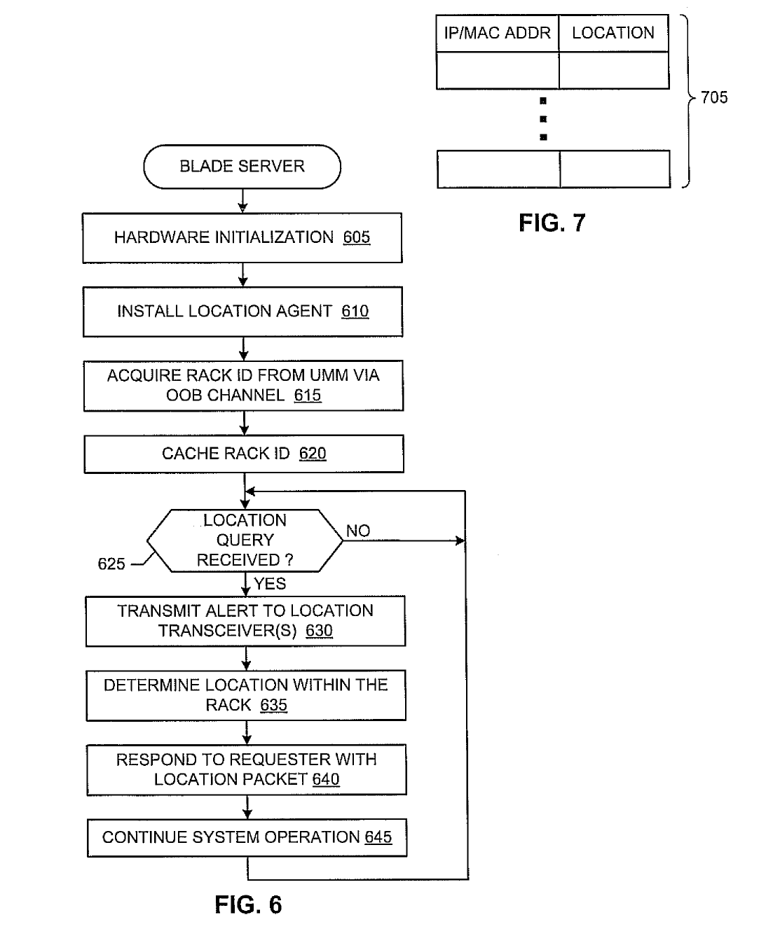

To determine a location and/or respond to a location request, the example coded instructions 305 of FIG. 3A include coded instructions 310 that implement a location agent. Example machine accessible instructions that may be used to implement the example location agent 310 of FIG. 3A are described below in connection with FIGS. 5 and 6. To implement a main and/or general operating system, the example coded instructions of FIG. 3A include main operating system coded instructions 315.

FIG. 3B illustrates another example manner of implementing the example coded instructions 230, 235 of FIG. 2. To implement an embedded IT partition, the example coded instructions of FIG. 3B, coded instructions 320 include embedded IT partition coded instructions 320 that may be executed by, for example, the example processor(s) 225 of FIG. 2.

To determine a location and/or respond to a location request, the example coded instructions 320 of FIG. 3B include coded instructions 310 that implement a location agent. Example machine accessible instructions that may be used to implement the example location agent 310 of FIG. 3B are described below in connection with FIGS. 5 and 6. To implement a main and/or general main partition, the example coded instructions of FIG. 3B include main partition coded instructions 325.

While the example location agent 310 of FIGS. 3A and 3B is implemented by executing one or more of a variety of software, firmware, processing thread(s) and/or subroutine(s) with the example processor(s) 225, the example location agent 310 of FIGS. 3A and/or 3B may be, additionally or alternatively, implemented using any number and/or type(s) of application specific integrated circuit(s) (ASIC(s)), programmable logic device(s) (PLD(s)), field programmable logic device(s) (FPLD(s)), discrete logic, hardware, firmware, etc. Also, some or all of the example location agent 310 may be implemented manually and/or as any combination(s) of any of the foregoing techniques, for example, the location agent 310 may be implemented by any combination(s) of firmware, software and/or hardware.

Returning to FIG. 2, the example processor(s) 225 is in communication with the main memory (including the RAM 240 and the ROM 245) via a bus 250. The example RAM 240 may be implemented by DRAM, SDRAM, and/or any other type of RAM device. The example ROM 245 may be implemented by flash memory and/or any other desired type of memory device. Access to the memories 240 and 245 is typically controlled by a memory controller (not shown). The RAM 240 and/or the ROM 245 may be used, for example, to store determined location information such as the example data structures of FIGS. 4A and 4B. For example, location information may be stored together with other values and/or parameters utilized by and/or accessible to active management technology(-ies), a manageability engine and/or an embedded IT partition and, thus, not readily accessible to a general user of the computing platform 200.

The example computing platform 200 of FIG. 2 also includes any number and/or type(s) of interface circuits 255. The example interface circuit 255 of FIG. 2 may implement any number and/or type(s) of interfaces, such as external memory interface(s), serial port(s), general purpose input/output port(s), etc. Additionally or alternatively, the interface circuit 255 may communicatively couple the example transceiver 210, the network interface 215 and/or the out-of-band interface 220 with the processor 225 and/or the example location agent 310.

While an example manner of implementing any or all of the example computing platforms 105, 120 of FIG. 1 is illustrated in FIG. 2, a computing platform 200 may be implemented using any of a variety of other and/or additional element(s), processor(s), device(s), component(s), circuit(s), module(s), interface(s), etc. Further, the element(s), processor(s), device(s), component(s), circuit(s), module(s), element(s), interface(s), etc. illustrated in FIG. 2 may be combined, divided, re-arranged, eliminated and/or implemented in any of a variety of ways. Additionally, any or all of the example computing platform 200 of FIG. 2 may be implemented as any combination of firmware, software, logic and/or hardware. Moreover, the example computing platform 200 may include additional processor(s), device(s), component(s), circuit(s), interface(s) and/or module(s) than those illustrated in FIG. 2 and/or may include more than one of any or all of the illustrated processor(s), device(s), component(s), circuit(s), interface(s) and/or module(s).

FIGS. 4A and 4B illustrate example data structures that may be used to implement a location packet. To identify a rack, the example data structure of FIG. 4A includes a rack identifier field 405. The example rack identifier field 405 contains a value that represents one or more of a site, a building, a lab, and/or a room, and/or a rack number within site, building, lab, and/or room. For example, the value may be formed as a concatenation of one or more values and/or alphanumeric strings that uniquely identify a site, a building, a lab, a room and a rack.

To identify the coordinates of a blade server 105 within the rack identified by the rack identifier field 405, the example data structure of FIG. 4A includes a coordinate(s) field 410. The example coordinate(s) field 410 contains one or more values that represent the shelf and/or slot within the rack that contains the blade server 105.

To specify one or more devices, applications, software, etc. implemented by the blade server 105, the example data structure of FIG. 4A contains a device list field 415. However, the device list field 415 need not be included in a location packet. The example device list field 415 of FIG. 4A lists and/or provides an inventory of devices, modules, application, software, etc. implemented by the blade server 105. Such a list may be used to identify blade servers 105 requiring, for example, an updated driver and/or software patch.

FIG. 4B illustrates an alternative data structure that may be used to implement a location packet. To identify a rack, the example data structure of FIG. 4B includes the rack identifier field 405. For a standalone computing platform 120, the example rack identifier field 405 of FIG. 4B may be unused. However, when the example data structure of FIG. 4B is used for a blade server, the example rack identifier field 405 of FIG. 4B contains a value that represents one or more of a site, a building, a lab, and/or a room, and/or a rack number within site, building, lab, and/or room. For example, the value may be formed as a concatenation of one or more numbers and/or alphanumeric strings that uniquely identify a site, a building, a lab, a room and/or a rack.

To specify the location of a computing platform 105, 120, the example data structure of FIG. 4B includes a site identification field 420. The example site identification field 420 contains one or more values that represent the physical location of a computing platform 105, 102. An example value is formed as a concatenation of one or more numbers and/or alphanumeric strings that uniquely identify a site, a building, a lab, a room and/or a rack. For example, a value of 2005031504 represents site #20=Jones Farm, building #05=Building JF5, floor #03=3_{rd} floor, pole #1504=electrical post F4.

To specify one or more devices, applications, software, etc. implemented by the blade server 105, the example data structure of FIG. 4B contains the example device list field 415. However, the device list field 415 need not be included in a location packet. The example device list field 415 of FIG. 4B lists and/or provides an inventory of devices, modules, application, software, etc. implemented by the blade server 105. Such a list may be used to identify blade servers 105 requiring, for example, an updated driver and/or software patch.

While example data structures that may be used to implement location packets are illustrated in FIGS. 4A and 4B, the example data structures may be implemented using any of a variety of other and/or additional fields and/or data. Further, the fields and/or data illustrated in FIGS. 4A and/or 4B may be combined, split, re-arranged, eliminated and/or implemented in any of a variety of ways. Moreover, the example data structures may include additional fields and/or data than those illustrated in FIGS. 4A and 4B and/or may include more than one of any or all of the illustrated fields and/or data.

FIGS. 5 and 6 are flowcharts representative of example machine accessible instructions that may be executed to implement the example location agent 310 of FIGS. 2, 3A and/or 3B and/or, more generally, the example computing platforms 105, 120 of FIG. 1. The example machine accessible instructions of FIGS. 5 and/or 6 may be executed by a processor, a controller and/or any other suitable processing device. For example, the example machine accessible instructions of FIGS. 5 and/or 6 may be embodied in coded instructions stored on a tangible medium such as a flash memory, a ROM and/or RAM associated with a processor (e.g., the example processor(s) 225 discussed above in connection with FIG. 2). Alternatively, some or all of the example flowcharts of FIGS. 5 and/or 6 may be implemented using any combination(s) of ASIC(s), PLD(s), FPLD(s), discrete logic, hardware, firmware, etc. Also, some or all of the example flowcharts of FIGS. 5 and/or 6 may be implemented manually or as any combination(s) of any of the foregoing techniques, for example, any combination of firmware, software, discrete logic and/or hardware. Further, although the example machine accessible instructions of FIGS. 5 and 6 are described with reference to the flowcharts of FIGS. 5 and 6, persons of ordinary skill in the art will readily appreciate that many other methods of implementing the example location agents 310 and/or, more generally, the example computing platforms 105, 120 may be employed. For example, the order of execution of the blocks may be changed, and/or some of the blocks described may be changed, eliminated, sub-divided, or combined. Additionally, persons of ordinary skill in the art will appreciate that the example machine accessible instructions of FIGS. 5 and/or 6 may be carried out sequentially and/or carried out in parallel by, for example, separate processing threads, processors, devices, discrete logic, circuits, etc.

The example machine accessible instructions of FIG. 5 begin with the initialization of the hardware of a computing platform (e.g., the example platform 200 of FIG. 2) (block 505), and installing and/or initiating a location agent (e.g., installing and/or initiating any of the example location agents 310 of FIGS. 3A and 3B) (block 510).

If the computing platform includes a transceiver (e.g., the example transceiver 210 of FIG. 2) (block 515), the location agent transmits an electromagnetic signal (e.g., a RF, a RFID and/or a WLAN signal) to nearby transceivers (e.g., one or more of the example transceivers 145-147, 150) (block 520) and determines its location based upon one or more received signals (block 525). Such received signals are transmitted by one or more transceivers (e.g., the example transceivers 145-147, 150 of FIG. 1) in response to receiving the electromagnetic signal transmitted by the location agent.

If the computing platform does not include a transceiver (block 515), the location agent broadcasts a request on a local subnet (e.g., of the example IP network 130 of FIG. 1) to locate and/or identify a location agent implemented by a nearby computing platform that can identify the location of the computing platform (block 530). Additionally or alternatively, the computing platform at block 530 locates and/or identifies a router (e.g. the example router 135 of FIG. 1), a switch, a bridge and/or gateway to which the computing platform is communicatively coupled.

When a location query is received (block 535), the location agent responds to the requester with a location packet (e.g., one of the example data structures of FIGS. 4A and 4B) (block 540) and continues system operation (block 545). Alternatively, before responding with a location packet at block 540, the location agent can determine its location by, for example, executing the machine access instructions represented by blocks 520 and 525.

The example machine accessible instructions of FIG. 6 begin with initialization of the hardware of a computing platform (e.g., the example platform 200 of FIG. 2) (block 605) and installing and/or initiating a location agent (e.g., installing and/or initiating one of the examples location agents 310 of FIGS. 3A and 3B) (block 610). The location agent then acquires a rack identifier from, for example, a UMM via an out-of-band communication channel (block 615) and caches and/or stores the obtained rack identifier (block 620).

When a location query is received (block 625), the location agent transmits an electromagnetic signal (e.g., a RF, a RFID and/or a WLAN signal) to one or more nearby transceivers (e.g., one or more of the example transceivers 145-147, 150 of FIG. 1) (block 630) and determines its location based upon one or more received signals (block 635). The location agent responds to the requester with a location packet (e.g., one of the example data structures of FIGS. 4A and 4B) (block 640) and continues system operation (block 645). Control then returns to block 625 to wait for another location query.

FIG. 7 illustrates an example data structure that may be used to implement a database that represents a plurality of locations 705 for respective ones of a plurality of computing platforms 105, 120. To identify a computing platform 105, 120, each of the example entries 705 of FIG. 7 includes an IP/MAC address field 710. The example IP/MAC address field 710 of FIG. 7 contains a value that represents at least one of the MAC address of a computing platform 105, 120 and/or an IP address assigned to the computing platform 105, 120.

To specify a location, each of the example entries 705 of FIG. 7 includes a location field 715. The example location field 715 of FIG. 7 contains one or more values that identify the physical location of a computing platform 105, 120. For example, the location field 715 may contain the value(s) from one or more of the example rack identifier field 405, the example coordinate(s) field 410, the site identifier field 420 of FIGS. 4A and/or 4B.

While example data structures that may be used to implement a database that represents the locations of computing platforms 105, 120, the example data structure may be implemented using any of a variety of other and/or additional fields and/or data. Further, the fields and/or data illustrated in FIG. 7 may be combined, split, re-arranged, eliminated and/or implemented in any of a variety of ways. Moreover, the example data structures may include additional fields and/or data than those illustrated in FIG. 7 and/or may include more than one of any or all of the illustrated fields and/or data.

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method comprising:
receiving a first electromagnetic signal at a computing platform;
determining a location of the computing platform based on the received electromagnetic signal within at least one of a manageability engine, active management technology or an embedded information technology (IT) partition; and
sending a location packet that contains the location and an identifier for the computing platform.

2. The method as defined in claim 1, further comprising receiving a second electromagnetic signal at the computing platform, wherein the location is determined based on the first and the second electromagnetic signals.

3. The method as defined in claim 1, further comprising receiving a query, wherein the receiving, the determining and the sending are performed in response to the query.

4. The method as defined in claim 1, wherein the first electromagnetic signal is at least one of a radio frequency (RF) signal, a wireless local area network (WLAN) signal, or a network routing packet.

5. The method as defined in claim 1, wherein the computing platform is a blade server.

6. The method as defined in claim 5, further comprising sending a request to a management module to determine a value that identifies a rack.

7. The method as defined in claim 5, wherein the location comprises a first value that represents the rack and a second value that represents a location within the rack.

8. The method as defined in claim 1, wherein the computing platform is a standalone computing platform.

9. The method as defined in claim 8, wherein the location comprises a value that represents at least one of a site or a location within a site.

10. An article of manufacture storing machine readable instructions which, when executed, cause a machine to:
receive an electromagnetic signal at a computing platform;
implement at least one of a manageability engine, active management technology or an embedded information technology (IT) partition to determine a location of the computing platform based on the received electromagnetic signal; and
send a location packet that contains the location and an identifier for the computing platform.

11. An article of manufacture as defined in claim 10, wherein the machine readable instructions, when executed, cause the machine to receive a query, wherein the receiving, the determining and the sending are performed in response to the query.

12. An article of manufacture as defined in claim 10, wherein the machine implements a blade server, the machine readable instructions, when executed, cause the machine to send a request to a management module to determine a value that identifies a rack.

13. An article of manufacture as defined in claim 12, wherein the location comprises a first value that represents the rack and a second value that represents a location within the rack.

14. An article of manufacture as defined in claim 10, wherein the machine implements a standalone computing platform.

15. An article of manufacture as defined in claim 14, wherein the location comprises a value that represents at least one of a site or a location within a site.

16. An apparatus comprising:
a signal receiver to receive an electromagnetic signal;
at least one of a manageability engine, active management technology or an embedded information technology (IT) partition; and
a location agent implemented by the at least one of a manageability engine, active management technology or an embedded information technology (IT) partition to determine a location of the computing platform based on the received electromagnetic signal, send a location packet that contains the location and a computing platform identifier.

17. An apparatus as defined in claim 16, wherein the electromagnetic signal is at least one of a radio frequency (RF) signal, a wireless local area network (WLAN) signal, or a network routing packet.

18. An apparatus as defined in claim 16, further comprising an edge connector to communicatively couple the location agent to a backplane of a rack of blade servers.

19. An apparatus as defined in claim 18, wherein the location comprises a first value that represents the rack and a second value that represents a location within the rack.

20. An apparatus as defined in claim 16, wherein the location comprises a value that represents at least one of a site or a location within a site.
